(19) United States
(12) Patent Application Publication
(10) Pub. No.: US 2026/0094568 A1
(43) Pub. Date: Apr. 2, 2026

(54) PIXEL CIRCUIT AND DISPLAY DEVICE INCLUDING THE SAME

(71) Applicant: LG Display Co., Ltd., Seoul (KR)

(72) Inventors: Hyung Uk JANG, Paju-si (KR); Jung Hoon LEE, Paju-si (KR)

(73) Assignee: LG Display Co., Ltd., Seoul (KR)

(21) Appl. No.: 19/262,727

(22) Filed: Jul. 8, 2025

(30) Foreign Application Priority Data
Sep. 27, 2024 (KR) 10-2024-0131581

(51) Int. Cl. G09G 3/3233; G09G 3/32

(52) U.S. Cl. CPC G09G 3/3233; G09G 3/32; G09G 2300/0819; G09G 2300/0852; G09G 2310/08; G09G 2320/045; G09G 2330/021

(57) ABSTRACT

A pixel circuit according to an embodiment and a display device including the same are disclosed. The pixel circuit includes a light-emitting element; a first driving element configured to drive the light-emitting element; a second driving element configured to drive the first driving element; a capacitor connected to a gate electrode of the second driving element; a first switch element configured to apply a data voltage to a second electrode of the capacitor; a second switch element configured to apply an off voltage to a first electrode of the capacitor; a third switch element connected between the first electrode of the capacitor and a first electrode of the second driving element; a fourth switch element configured to apply a pixel ground voltage to the first electrode of the second driving element; a fifth switch element configured to apply a pixel driving voltage to a second electrode of the second driving element; and a sixth switch element connected between the light-emitting element and the first driving element.

### CROSS-REFERENCE TO RELATED APPLICATION

This application claims priority to and the benefit of Korean Patent Application No. 10-2024-0131581, filed September 27, 2024, the disclosure of which is incorporated herein by reference in its entirety.

### BACKGROUND

### Technical Field

The present disclosure relates to a pixel circuit and a display device including the same.

### Description of the Related Art

Various flat panel display devices such as a liquid crystal display device, an electroluminescent display device, and the like are known. The electroluminescent display device may display an input image by emitting light by itself without a backlight by using the light-emitting elements disposed on each of the pixels. The light-emitting elements of the electroluminescent display device may be divided into an organic light-emitting element and an inorganic light-emitting element according to the material of the light-emitting layer.

Recently, a display device that uses a light-emitting diode (LED), an inorganic light-emitting element, as a light-emitting element of a pixel has attracted attention as a next-generation display device. Since LEDs are made of inorganic materials, they do not require a separate encapsulation layer to protect organic materials from moisture, and they are more reliable and have a longer lifespan than organic light-emitting diodes (OLEDs). In addition, LEDs have a fast lighting speed, excellent luminous efficiency, and impact resistance.

### BRIEF SUMMARY

Each of the plurality of pixels includes a driving element that controls the driving current flowing through the light-emitting element according to the voltage (Vgs) applied between the gate electrode and the source electrode. The electrical characteristics of the driving elements may deteriorate over time and vary from pixel to pixel.

In addition, since the emission time of the light-emitting element is controlled by using the driving current, it is difficult to utilize the light-emitting element only in the maximum efficiency range thereof, so the light-emitting element is driven with high power consumption.

The present disclosure provides a pixel circuit capable of reducing power consumption and a display device including the same.

It should be noted that features of the present disclosure are not limited to the above-described features, and other features of the present disclosure will be apparent to those skilled in the art from the following descriptions.

A pixel circuit according to embodiments of the present disclosure may include a light-emitting element; a first driving element configured to drive the light-emitting element; a second driving element configured to drive the first driving element; a capacitor connected to a gate electrode of the second driving element; a first switch element configured to apply a data voltage to a second electrode of the capacitor; a second switch element configured to apply an off voltage to a first electrode of the capacitor; a third switch element connected between the first electrode of the capacitor and a first electrode of the second driving element; a fourth switch element configured to apply a pixel ground voltage to the first electrode of the second driving element; a fifth switch element configured to apply a pixel driving voltage to a second electrode of the second driving element; and a sixth switch element connected between the light-emitting element and the first driving element.

A display device according to embodiments of the present disclosure may include a pixel array in which a plurality of data lines, a plurality of gate lines, and a plurality of pixel circuits are arranged; a data driver configured to output a data voltage to the plural data lines; and a gate driver configured to output a gate signal to the plural gate lines, wherein each of the pixel circuits includes: a light-emitting element; a first driving element to drive the light-emitting element; a second driving element to drive the first driving element; a capacitor connected to a gate electrode of the second driving element; a first switch element configured to apply a data voltage to a second electrode of the capacitor; a second switch element configured to apply an off voltage to a first electrode of the capacitor; a third switch element connected between the first electrode of the capacitor and a first electrode of the second driving element; a fourth switch element configured to apply a pixel ground voltage to the first electrode of the second driving element; a fifth switch element configured to apply a pixel driving voltage to a second electrode of the second driving element; and a sixth switch element connected between the light-emitting element and the first driving element.

In the present disclosure, a first driving element for driving the light-emitting element and a second driving element for driving the first driving element are configured, and the turn-on time of the second driving element for turning off the first driving element is controlled by using the data voltage, thereby making it possible to utilize the maximum efficiency range by adjusting the emission time of the light-emitting element according to the data voltage.

In the present disclosure, the first driving element is used as a switch element, and the threshold voltage of the second driving element is compensated, so that the emission time of the light-emitting element may be controlled by using the data voltage with no deviation between pixels.

In the present disclosure, it is possible to apply PWM driving based on the maximum efficiency range of the light-emitting element.

In the present disclosure, low-power driving is possible because the maximum efficiency range of the light-emitting element is used.

The effects of the present specification are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIG. 2 is a diagram illustrating a pixel circuit according to a first embodiment of the present disclosure;

FIG. 3 is a diagram illustrating the driving timing of the pixel circuit shown in FIG. 2;

FIGS. 4A to 4E are diagrams for describing the operating principle of the pixel circuit according to FIG. 3;

FIGS. 5A and 5B are diagrams for describing the emission time according to the data voltage;

FIG. 6 is a diagram illustrating a pixel circuit according to a second embodiment of the present disclosure;

FIG. 7 is a diagram illustrating the driving timing of the pixel circuit shown in FIG. 6; and

FIGS. 8A to 8E are diagrams for describing the operating principle of the pixel circuit according to FIG. 7.

### DETAILED DESCRIPTION

Advantages and features of the present specification and methods of achieving them will become apparent with reference to example embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to,’ and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

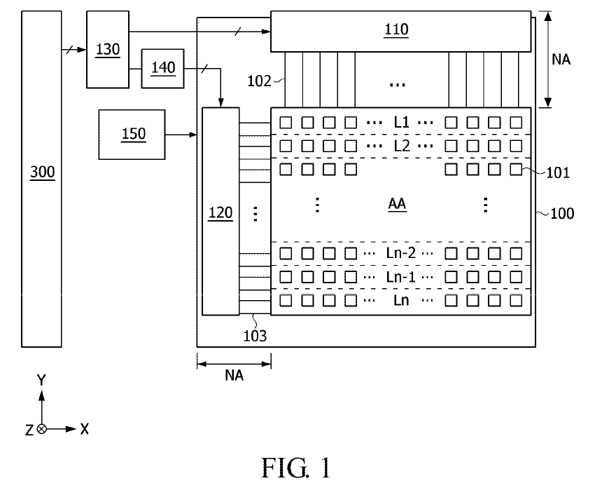

FIG. 1 is a block diagram illustrating a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The pixels may be arranged as real color pixels and pentile pixels. A pentile pixel may realize a higher resolution than a real color pixel by driving two sub-pixels with different colors as one pixel 101 and using a preset pixel rendering algorithm. This pixel rendering algorithm may compensate for insufficient color representation in each pixel with the color of light emitted from adjacent pixels.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

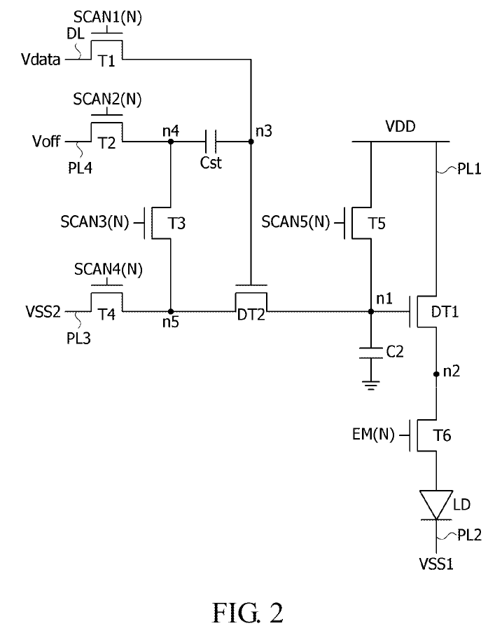

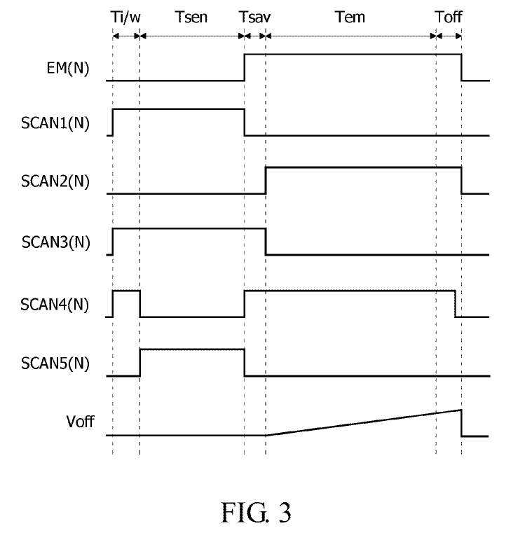

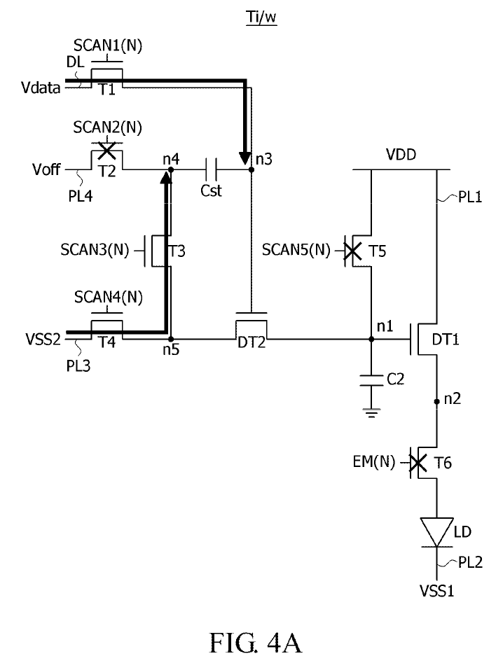

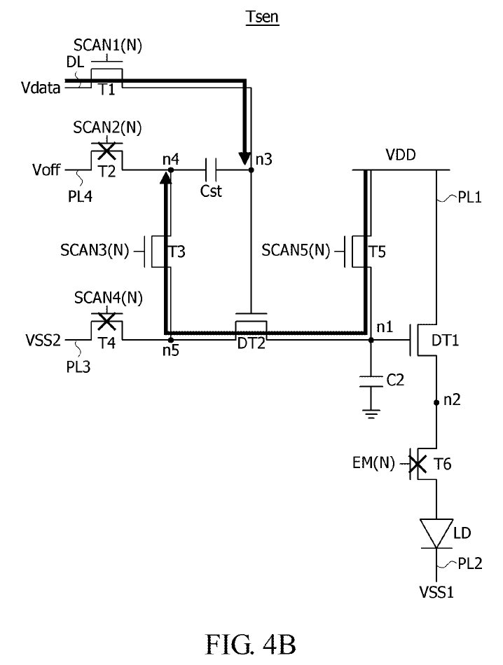

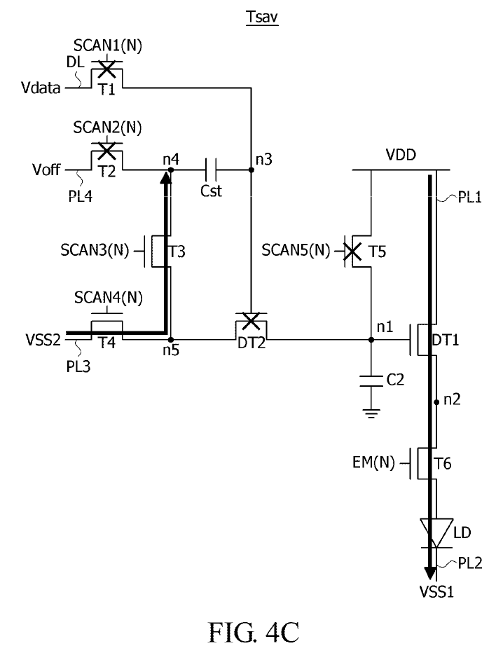

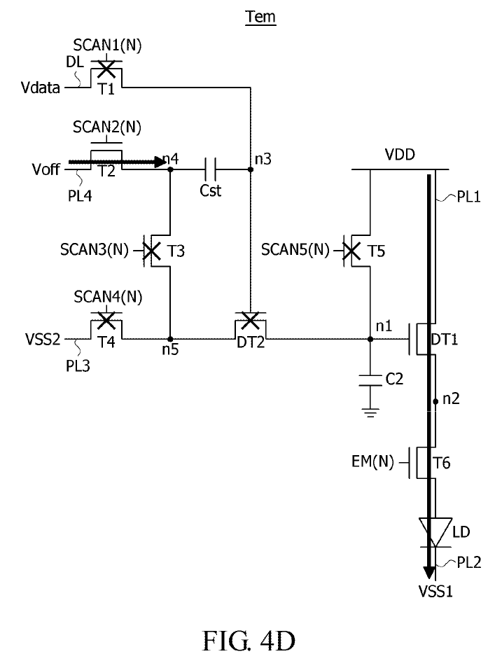

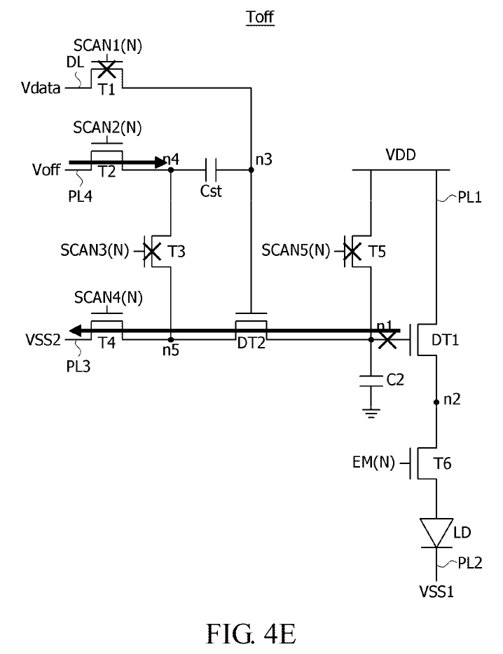

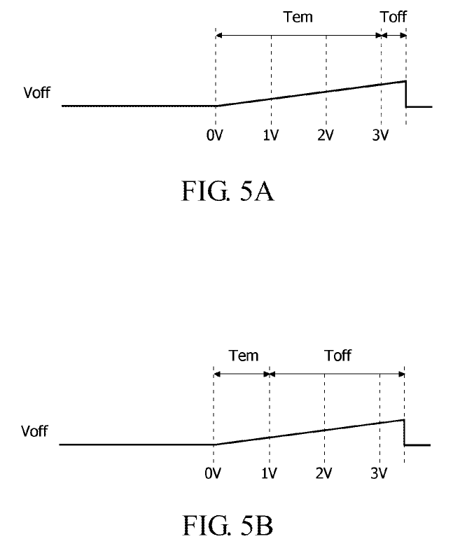

FIG. 2 is a diagram illustrating a pixel circuit according to a first embodiment of the present disclosure, FIG. 3 is a diagram illustrating the driving timing of the pixel circuit shown in FIG. 2, FIGS. 4A to 4E are diagrams for describing the operating principle of the pixel circuit according to FIG. 3, and FIGS. 5A and 5B are diagrams for describing the emission time according to the data voltage.

Referring to FIGS. 2 and 3, the pixel circuit according to the first embodiment of the present disclosure includes a light-emitting element LD, a first driving element DT1 and a second driving element D2 that supply a current to the light-emitting element LD, a plurality of switch elements T1, T2, T3, T4, T5 and T6 that switch the current path connected to the first driving element DT1, a first capacitor Cst, and a second capacitor C2. The first and second driving elements DT1 and DT2, and the switch elements T1, T2, T3, T4, T5 and T6 may be implemented with, but not limited to, n-channel transistors.

The light-emitting element LD may include an anode electrode, a cathode electrode, and an emission layer. The cathode electrode of the light-emitting element LD may be connected to a first power line PL1 to which a pixel driving voltage EVDD is applied. The anode electrode of the light-emitting element LD may be connected to the first driving element DT1. The light-emitting element LD may be a light-emitting element such as an OLED, mini-LED, or micro-LED, but is not limited thereto. In the case of a mini-LED or micro-LED, the light-emitting element LD may have a vertical structure in which electrodes are arranged on the upper and lower parts of a semiconductor chip in which the light-emitting element LD is integrated, but is not limited thereto. The semiconductor chip in which the light-emitting element LD is integrated may be implemented in a lateral structure or a flip chip structure.

The first driving element DT1 may drive the light-emitting element LD in response to the voltage of the first node n1. The first driving element DT1 includes a gate electrode connected to the first node n1, a first electrode connected to the first power line PL1 to which the pixel driving voltage VDD is applied, and a second electrode connected to the second node n2.

The second driving element DT2 may drive the first driving element DT1 in response to the voltage of the third node n3. When turned on by the voltage of the third node n3, the second driving element DT2 may connect the fifth node n5, to which the second pixel ground voltage VSS2 is applied, to the first node n1 to discharge the voltage of the first node n1 to the second pixel ground voltage VSS2, thereby controlling the emission time of the light-emitting element LD by turning off the first driving element DT1. The second driving element DT2 includes a gate electrode connected to the third node n3, a first electrode connected to the fifth node n5, and a second electrode connected to the first node n2.

In an embodiment, the emission time of the light-emitting element may be controlled by using the first driving element DT1 and the second driving element DT2. The first driving element DT1 may be used as a switch element, and the second driving element DT2 may control the time at which the first driving element DT1 is turned on.

The first switch element T1 supplies the data voltage Vdata to the gate electrode of the second driving element DT2 in response to the first scan signal [SCAN1(N)]. The first switch element T1 includes a gate electrode to which the first scan signal SCAN1(N) is applied, a first electrode connected to the data line DL to which the data voltage is applied, and a second electrode connected to the third node n3.

The second switch element T2 applies the off voltage Voff to the fourth node n4 in response to the second scan signal [SCAN2(N)]. The second switch element T2 includes a gate electrode to which the second scan signal [SCAN2(N)] is applied, a first electrode connected to the fourth power line PL4 to which the off voltage Voff is applied, and a second electrode connected to the fourth node n4.

The third switch element T3 connects the fourth node n4 and the fifth node n5 in response to the third scan signal [SCAN3(N)]. The third switch element T3 includes a gate electrode to which the third scan signal [SCAN3(N)] is applied, a first electrode connected to the fourth node n4, and a second electrode connected to the fifth node n5.

The fourth switch element T4 discharges the voltage of the fifth node n5 to the second pixel ground voltage VSS2 in response to the fourth scan signal [SCAN4(N)]. The fourth switch element T4 includes a gate electrode to which the fourth scan signal [SCAN4(N)] is applied, a first electrode connected to the third power line PL3 to which the second pixel ground voltage VSS2 is applied, and a second electrode connected to the fifth node n5.

The fifth switch element T5 connects the first power line to the first node n1 in response to the fifth scan signal [SCAN5(N)]. The fifth switch element T5 includes a gate electrode to which the fifth scan signal [SCAN5(N)] is applied, a first electrode connected to the first power line PL1, and a second electrode connected to the first node n1.

The sixth switch element T6 connects the second node n2 to the anode electrode of the light-emitting element LD in response to the emission control signal [EM(N)]. The sixth switch element T6 includes a gate electrode to which the emission control signal [EM(N)] is applied, a first electrode connected to the second node n2, and a second electrode connected to the anode electrode of the light-emitting element LD.

The first capacitor Cst is connected between the third node n3 and the fourth node n4. The first capacitor Cst may store the threshold voltage Vth of the second driving element DT2. The first electrode of the first capacitor Cst is connected to the fourth node n4, and the second electrode thereof is connected to the third node n3.

The second capacitor C2 is connected between the first node n1 and the ground. The second capacitor C2 may stably maintain the voltage applied to the first node n1. For example, when the pixel driving voltage VDD is applied to the first node n1, the second capacitor C2 may maintain the pixel driving voltage VDD applied to the first node n1 as it is.

The pixel circuit described herein is only a non-limiting example.

The pixel circuit according to the first embodiment of FIG. 2 may be operated in the driving order of initialization and data writing stage Ti/w, sensing stage Tsen, storage stage Tsav, emission stage Tem, and non-emission stage Toff.

Referring to FIG. 3 and FIG. 4A, in the initialization and data writing stage Ti/w, the second switch element T2 and the fifth to sixth switch elements T5 and T6 are turned off, and the first switch element T1 is turned on, so that the data voltage Vdata is applied to the third node n3. As a result, the voltage of the third node n3 becomes ‘Vdata.’

The third to fourth switch elements T3 and T4 are turned on, and the voltage of the fourth node n4 is discharged to the second pixel ground voltage VSS2 and initialized. As a result, the voltage of the fourth node n4 becomes ‘VSS2=0.’

Referring to FIG. 3 and FIG. 4B, in the sensing stage Tsen, the first switch element T1 is turned on, and the data voltage Vdata is applied to the third node n3; the third switch element T3 and the fifth switch element T5 are turned on, and the threshold voltage Vth of the second driving element DT2 is sensed and stored in the first capacitor Cst connected to the fourth node n2. As a result, the voltage of the third node n3 becomes ‘Vdata,’ and the voltage of the fourth node n4 and the fifth node n5 become ‘Vdata-Vth.’

In an embodiment, since the first driving element DT1 is used as a switch element, the threshold voltage of the first driving element DT1 is not compensated but the threshold voltage of the second driving element DT2 is compensated.

Referring to FIG. 3 and FIG. 4C, in the storage stage Tsav, the third to fourth switch elements T3 and T4 are turned on, the second pixel ground voltage VSS2 is applied to the fourth node n4, and the threshold voltage Vth stored in the first capacitor Cst is stored in the third node n3. As a result, the voltage of the fourth node n4 becomes ‘0’ and the voltage of the third node n3 becomes ‘Vdata+Vth.’

At this time, a current flows to the light-emitting element LD through the first driving element DT1, causing the light-emitting element LD to emit light.

Referring to FIG. 3 and FIG. 4D, in the emission stage Tem, the second switch element T2 is turned on, and the off voltage Voff is applied to the first capacitor Cst to increase the voltage of the third node n3.

The voltage of the third node n3 becomes ‘Vdata+Vth+Voff’ and increases by the off voltage Voff. Here, the off voltage Voff as a variable voltage value may be, but not limited to, a voltage value that increases by a preset amount.

The sixth switch element T6 is turned on, and a current flows through the driving element DT, causing the light-emitting element LD to emit light.

Referring to FIG. 3 and FIG. 4E, in the non-emission stage Toff, the second switch element T2 is maintained in the turned-on state, the voltage of the third node n3 increases, the second driving element DT2 is turned on, and the voltage of the first node n1 is discharged to the second pixel ground voltage VSS2, so that the first driving element DT1 is turned off and the light-emitting element LD does not emit light.

The voltage of the third node n3, ‘Vdata+Vth+Voff,’ rises to or above the gate-on voltage capable of turning on the second driving element DT2, and as a result, when the second driving element DT2 is turned on, the first driving element DT1 is turned off.

Here, the voltage of the third node n3 varies depending on the data voltage Vdata and the off voltage Voff. Since the off voltage Voff is a voltage that increases by a constant amount, the time required for it to increase to the gate-on voltage may vary depending on the data voltage Vdata.

For example, assuming that the gate-on voltage is 3 V, when the data voltage Vdata is 0 V as shown in FIG. 5A, the off voltage Voff should be 3 V to reach the gate-on voltage.

On the other hand, when the data voltage Vdata is 2 V as in FIG. 5B, the gate-on voltage is reached if the off voltage Voff becomes 1 V, which shortens the emission time.

Therefore, the emission time of the light-emitting element may vary depending on the data voltage Vdata. That is, in the first embodiment, depending on the data voltage and the off voltage, the higher the data voltage, the shorter the emission time, and the lower the data voltage, the longer the emission time.

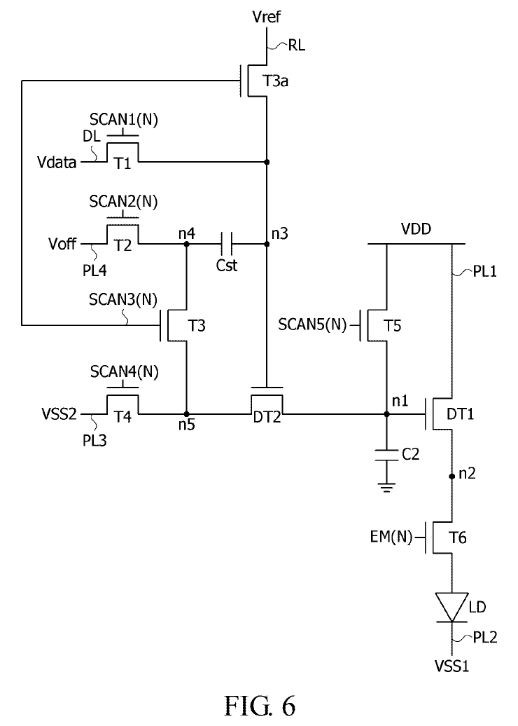

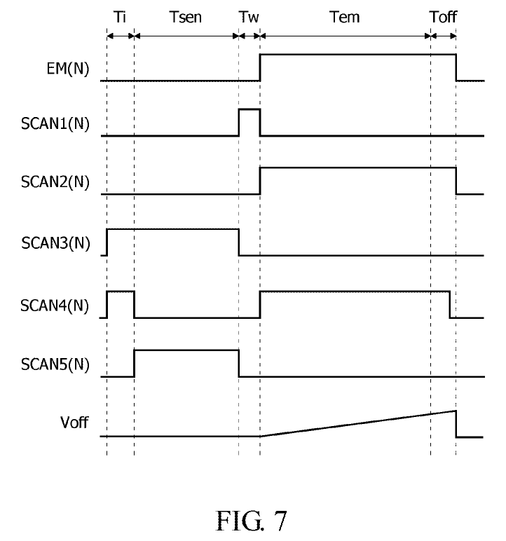

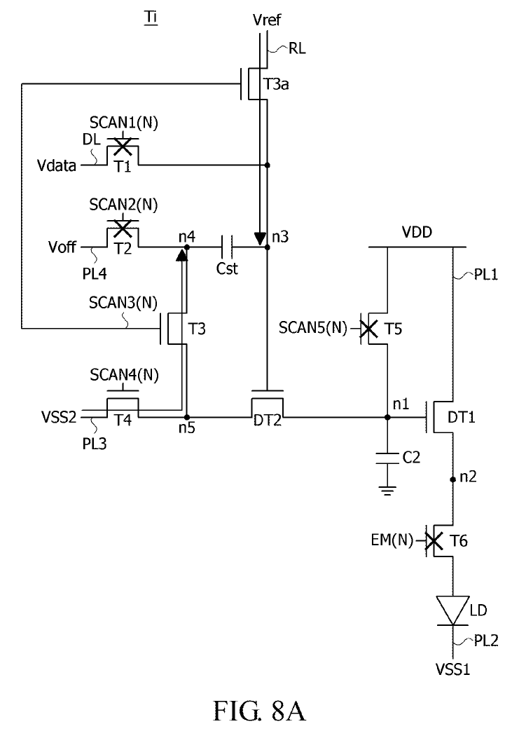

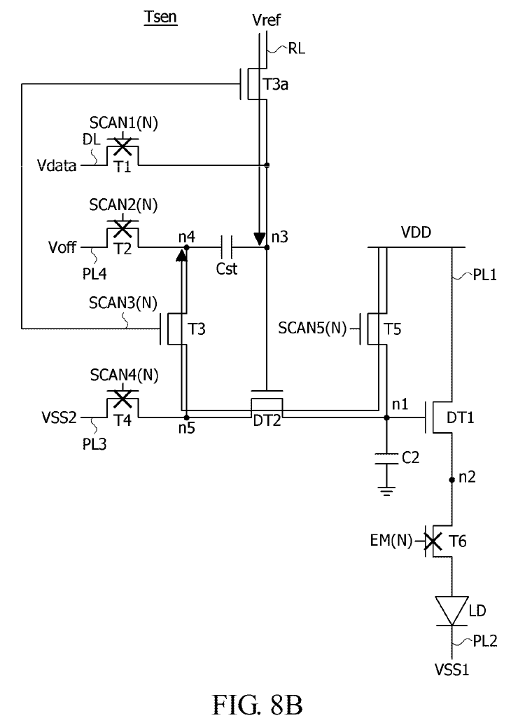

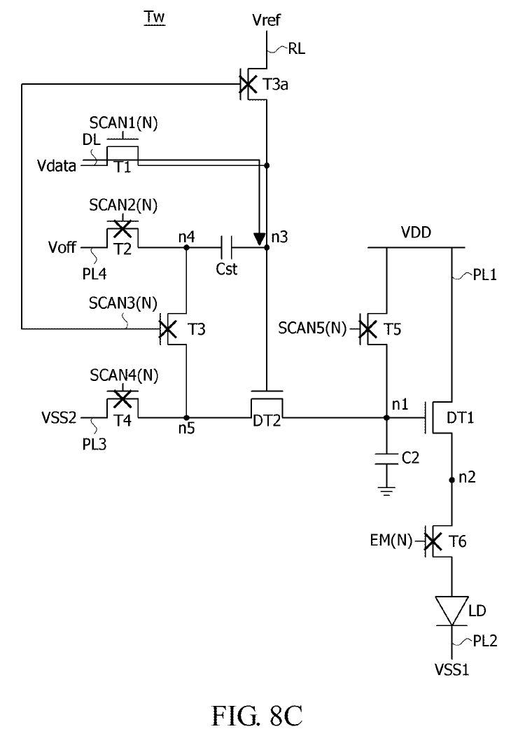

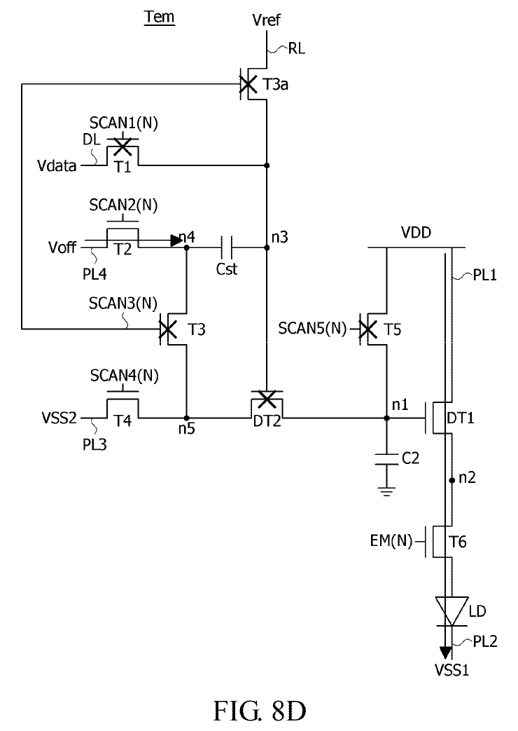

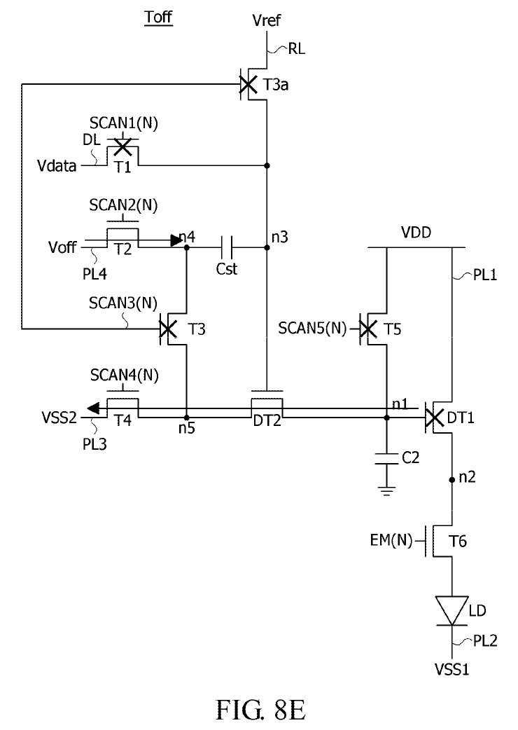

FIG. 6 is a diagram illustrating a pixel circuit according to a second embodiment of the present disclosure, FIG. 7 is a diagram illustrating the driving timing of the pixel circuit shown in FIG. 6, and FIGS. 8A to 8E are diagrams for describing the operating principle of the pixel circuit according to FIG. 7.

Referring to FIGS. 6 and 7, the pixel circuit according to the second embodiment of the present disclosure includes a light-emitting element LD, a first driving element DT1 and a second driving element D2 that supply a current to the light-emitting element LD, a plurality of switch elements T1, T2, T3, T3a, T4, T5 and T6 that switch current paths connected to the first driving element DT1, a first capacitor Cst, and a second capacitor C2. The first and second driving elements DT1 and DT2, and the switch elements T1, T2, T3, T3a, T4, T5 and T6 may be implemented with, but not limited to, n-channel transistors.

The light-emitting element LD may include an anode electrode, a cathode electrode, and an emission layer. The cathode electrode of the light-emitting element LD may be connected to the second power line PL2 to which the first pixel ground voltage VSS1 is applied. The anode electrode of the light-emitting element LD may be connected to the first driving element DT1. The light-emitting element LD may be, but not limited to, an emission element such as OLED, mini LED, or micro LED.

The first driving element DT1 may drive the light-emitting element LD in response to the voltage of the first node n1. The first driving element DT1 includes a gate electrode connected to the first node n1, a first electrode connected to the first power line PL1 to which the pixel driving voltage VDD is applied, and a second electrode connected to the second node n2.

The second driving element DT2 may drive the first driving element DT1 in response to the voltage of the third node n3. When turned on by the voltage of the third node n3, the second driving element DT2 may connect the fifth node n5, to which the second pixel ground voltage VSS2 is applied, to the first node n1 to discharge the voltage of the first node n1 to the second pixel ground voltage VSS2, thereby controlling the emission time of the light-emitting element LD by turning off the first driving element DT1. The second driving element DT2 includes a gate electrode connected to the third node n3, a first electrode connected to the fifth node n5, and a second electrode connected to the first node n1.

The first switch element T1 supplies the data voltage Vdata to the gate electrode of the second driving element DT2 in response to the first scan signal [SCAN1(N)]. The first switch element T1 includes a gate electrode to which the first scan signal SCAN1(N) is applied, a first electrode connected to the data line DL to which the data voltage is applied, and a second electrode connected to the third node n3.

The second switch element T2 applies the off voltage Voff to the fourth node n4 in response to the second scan signal [SCAN2(N)]. The second switch element T2 includes a gate electrode to which the second scan signal [SCAN2(N)] is applied, a first electrode connected to the fourth power line PL4 to which the off voltage Voff is applied, and a second electrode connected to the fourth node n4.

The third switch element T3 connects the fourth node n4 and the fifth node n5 in response to the third scan signal [SCAN3(N)]. The third switch element T3 includes a gate electrode to which the third scan signal [SCAN3(N)] is applied, a first electrode connected to the fourth node n4, and a second electrode connected to the fifth node n5.

The third-a switch element T3a applies the reference voltage Vref to the third node n3 in response to the third scan signal [SCAN3(N)]. The third-a switch element T3a includes a gate electrode to which the third scan signal [SCAN3(N)] is applied, a first electrode connected to the reference voltage line RL to which the reference voltage Vref is applied, and a second electrode connected to the third node n3.

The fourth switch element T4 discharges the voltage of the fifth node n5 to the second pixel ground voltage VSS2 in response to the fourth scan signal [SCAN4(N)]. The fourth switch element T4 includes a gate electrode to which the fourth scan signal [SCAN4(N)] is applied, a first electrode connected to the third power line PL3 to which the second pixel ground voltage VSS2 is applied, and a second electrode connected to the fifth node n5.

The fifth switch element T5 connects the first power line to the first node n1 in response to the fifth scan signal [SCAN5(N)]. The fifth switch element T5 includes a gate electrode to which the fifth scan signal [SCAN5(N)] is applied, a first electrode connected to the first power line PL1, and a second electrode connected to the first node n1.

The sixth switch element T6 connects the second node n2 to the anode electrode of the light-emitting element LD in response to the emission control signal EM(N). The sixth switch element T6 includes a gate electrode to which the emission control signal [EM(N)] is applied, a first electrode connected to the second node n2, and a second electrode connected to the anode electrode of the light-emitting element LD.

The first capacitor Cst is connected between the third node n3 and the fourth node n4. The first capacitor Cst may store the threshold voltage Vth of the second driving element DT2.

The second capacitor C2 is connected between the first node n1 and the ground. The second capacitor C2 may stably maintain the voltage applied to the first node n1.

The pixel circuit described herein is only a non-limiting example.

The pixel circuit according to the second embodiment in FIG. 6 may be operated in the driving order of initialization stage Tini, sensing stage Tsen, data writing stage Tsav, emission stage Tem, and non-emission stage Toff.

Referring to FIG. 7 and FIG. 8A, in the initialization stage Ti, the first to second switch elements T1 and T2 and the fifth to sixth switch elements T5 and T6 are turned off, the third-a switch element T3a is turned on, and the reference voltage Vref is applied to the third node n3 for initialization. As a result, the voltage of the third node n3 becomes ‘Vref.’

The third and fourth switch elements T3 and T4 are turned on, and the second pixel ground voltage VSS2 is applied to the fourth node n4 for initialization. As a result, the voltage of the fourth node n4 becomes ‘VSS2=0.’

Referring to FIG. 7 and FIG. 8B, in the sensing stage Tsen, the first to second switch elements T1 and T2, the fourth switch element T4, and the sixth switch element T6 are turned off, the third switch element T3 is turned on, the reference voltage Vref is applied to the third node n3, the third-a switch element T3a and the fifth switch element T5 are turned on, and the threshold voltage Vth of the second driving element DT2 is sensed and stored in the first capacitor Cst connected to the fourth node n4. As a result, the voltage of the third node n3 becomes ‘Vref,’ and the voltage of the fourth node n4 and the fifth node n5 becomes ‘Vref-Vth.’

Here, in the second embodiment, since the reference voltage Vref is applied to the third node n3 for initialization through the reference voltage line RL connected to all pixels and then the sensing stage is performed, it may be possible to collectively sense the threshold voltage of the second driving element DT2 in all pixels.

Referring to FIG. 7 and FIG. 8C, in the data writing stage Tw, the second switch element T2, the third switch element T31, the third-a switch element T3a, the fourth switch element T4, and the fifth to sixth switch elements T5 and T6 are turned off, and the first switch element T1 is turned on, so that the data voltage Vdata is applied to the third node n3. As a result, the voltage of the third node n3 becomes ‘Vref+Vdata.’

Referring to FIG. 7 and FIG. 8D, in the emission stage Tem, the first switch element T1, the third switch element T31, the third-a switch element T3a, and the fifth switch element T5 are turned off, the second switch element T2 is turned on, and the off voltage Voff is applied to the first capacitor Cst to increase the voltage of the third node n3.

The voltage of the third node n3 becomes ‘Vref+Vdata+Vth+Voff’ and increases due to the off voltage Voff.

The sixth switch element T6 is turned on, and a current flows through the driving element DT, causing the light-emitting element LD to emit light.

Referring to FIG. 7 and FIG. 8E, in the non-emission stage Toff, the first switch element T1, the third switch element T3, the third-a switch element T3a, and the fifth switch element T5 are turned off, the second switch element T2 is maintained in the turned-on state to increase the voltage of the third node n3, the second driving element DT2 is turned on, the voltage of the first node n1 is discharged to the second pixel ground voltage VSS2, so that the first driving element DT1 is turned off and the light-emitting element LD does not emit light.

The voltage of the third node n3, ‘Vref+Vdata+Vth+Voff,’ rises to or above the gate-on voltage capable of turning on the second driving element DT2, and as a result, when the second driving element DT2 is turned on, the first driving element DT1 is turned off.

Here, the voltage of the third node n3 varies depending on the data voltage Vdata and the off voltage Voff. Since the off voltage Voff is a voltage that increases by a constant amount, the time required for it to increase to the gate-on voltage may vary depending on the data voltage Vdata.

Therefore, in the second embodiment, depending on the data voltage and the off voltage, the higher the data voltage, the shorter the emission time, and the lower the data voltage, the longer the emission time.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A pixel circuit comprising:
a light-emitting element;
a first driving element configured to drive the light-emitting element;
a second driving element configured to drive the first driving element;
a capacitor connected to a gate electrode of the second driving element;
a first switch element configured to apply a data voltage to a second electrode of the capacitor;
a second switch element configured to apply an off voltage to a first electrode of the capacitor;
a third switch element connected between the first electrode of the capacitor and a first electrode of the second driving element;
a fourth switch element configured to apply a pixel ground voltage to the first electrode of the second driving element;
a fifth switch element configured to apply a pixel driving voltage to a second electrode of the second driving element; and
a sixth switch element connected between the light-emitting element and the first driving element.

2. The pixel circuit of claim 1, wherein the off voltage includes a voltage value of a preset magnitude.

3. The pixel circuit of claim 2, wherein an emission time of the light-emitting element varies based on a magnitude of the data voltage.

4. The pixel circuit of claim 1, wherein:
the first driving element includes a gate electrode connected to a first node, a first electrode connected between first power lines to which the pixel driving voltage is configured to be applied, and a second electrode connected to a second node;
the second driving element includes a gate electrode connected to a third node, a first electrode connected to a fifth node, and a second electrode connected to the first node;
the capacitor includes the first electrode connected to a fourth node, and the second electrode connected to the third node;
the first switch element includes a gate electrode to which a first scan signal is configured to be applied, a first electrode to which the data voltage is applied, and a second electrode connected to the third node;
the second switch element includes a gate electrode to which a second scan signal is configured to be applied, a first electrode to which the off voltage is applied, and a second electrode connected to the fourth node;
the third switch element includes a gate electrode to which a third scan signal is configured to be applied, a first electrode connected to the fourth node, and a second electrode connected to the fifth node;
the fourth switch element includes a gate electrode to which a fourth scan signal is configured to be applied, a first electrode to which the pixel ground voltage is applied, and a second electrode connected to the fifth node;
the fifth switch element includes a gate electrode to which a fifth scan signal is configured to be applied, a first electrode to which the pixel driving voltage is applied, and a second electrode connected to the first node; and
the sixth switch element includes a gate electrode to which an emission control signal is configured to be applied, a first electrode connected to the second node, and a second electrode connected to the light-emitting element.

5. The pixel circuit of claim 4, wherein:
the pixel circuit is configured to be driven in order of an initialization and data writing stage, a sensing stage, a storage stage, an emission stage, and a non-emission stage; and
in the initialization and data writing stage, the first switch element is configured to be turned on to thereby apply the data voltage to the third node, and the third and fourth switch elements are configured to be turned on to thereby apply the pixel ground voltage to the fourth node.

6. The pixel circuit of claim 5, wherein in the sensing stage, the first switch element is configured to be turned on to thereby apply the data voltage to the third node, and the third switch element and the fifth switch element are configured to be turned to thereby store a threshold voltage of the second driving element in the capacitor.

7. The pixel circuit of claim 6, wherein in the storage stage, the third and fourth switch elements are configured to be turned on to thereby apply the pixel ground voltage to the fourth node, and the sixth switch element is configured to be turned on to cause the light-emitting element to emit light.

8. The pixel circuit of claim 7, wherein in the emission stage, the second switch element is configured to be turned on to thereby apply the off voltage to the fourth node, and the sixth switch element is configured to be turned on to cause the light-emitting element to emit light.

9. The pixel circuit of claim 8, wherein in the non-emission stage, the second switch element is configured to be turned on to thereby apply the off voltage to the fourth node, and the fourth switch is configured to be turned on to thereby discharge voltages of the first node and the fifth node to the pixel ground voltage.

10. The pixel circuit of claim 4, further comprising:
a third-a switch element that includes a gate electrode to which the third scan signal is configured to be applied, a first electrode to which a reference voltage is configured to be applied, and a second electrode connected to the third node.

11. The pixel circuit of claim 10, wherein:
the pixel circuit is configured to be driven in order of an initialization stage, a sensing stage, a data writing stage, an emission stage, and a non-emission stage; and
in the initialization stage, the third-a switch element is configured to be turned on to thereby apply the reference voltage to the third node, and the third and fourth switch elements are configured to be turned on to thereby apply the pixel ground voltage to the fourth node.

12. The pixel circuit of claim 11, wherein in the sensing stage, the third-a switch element is configured to be turned on to thereby apply the reference voltage to the third node, and the third switch element and the fifth switch element are configured to be turned on to thereby store a threshold voltage of the second driving element in the capacitor.

13. The pixel circuit of claim 12, wherein in the data writing stage, the first switch element is configured to be turned on to thereby apply the data voltage to the third node.

14. The pixel circuit of claim 13, wherein in the emission stage, the second switch element is configured to be turned on to thereby apply the off voltage to the fourth node, and the sixth switch element is configured to be turned on to cause the light-emitting element to emit light.

15. The pixel circuit of claim 14, wherein in the non-emission stage, the second switch element is configured to be turned on to thereby apply the off voltage to the fourth node, and the fourth switch is configured to be turned on to thereby discharge voltages of the first node and the fifth node to the pixel ground voltage.

16. A display device comprising:
a pixel array in which a plurality of data lines, a plurality of gate lines, and a plurality of pixel circuits are arranged;
a data driver configured to output a data voltage to the plural data lines; and
a gate driver configured to output a gate signal to the plural gate lines,
wherein each of the pixel circuits includes:
a light-emitting element;
a first driving element to drive the light-emitting element;
a second driving element to drive the first driving element;
a capacitor connected to a gate electrode of the second driving element;
a first switch element configured to apply a data voltage to a second electrode of the capacitor;
a second switch element configured to apply an off voltage to a first electrode of the capacitor;
a third switch element connected between the first electrode of the capacitor and a first electrode of the second driving element;
a fourth switch element configured to apply a pixel ground voltage to the first electrode of the second driving element;
a fifth switch element configured to apply a pixel driving voltage to a second electrode of the second driving element; and
a sixth switch element connected between the light-emitting element and the first driving element.

17. The display device of claim 16, wherein:
the first driving element includes a gate electrode connected to a first node, a first electrode connected between first power lines to which the pixel driving voltage is configured to be applied, and a second electrode connected to a second node;
the second driving element includes a gate electrode connected to a third node, a first electrode connected to a fifth node, and a second electrode connected to the first node;
the capacitor includes a first electrode connected to a fourth node, and a second electrode connected to the third node;
the first switch element includes a gate electrode to which a first scan signal is configured to be applied, a first electrode to which the data voltage is configured to be applied, and a second electrode connected to the third node;
the second switch element includes a gate electrode to which a second scan signal is configured to be applied, a first electrode to which the off voltage is configured to be applied, and a second electrode connected to the fourth node;
the third switch element includes a gate electrode to which a third scan signal is configured to be applied, a first electrode connected to the fourth node, and a second electrode connected to the fifth node;
the fourth switch element includes a gate electrode to which a fourth scan signal is configured to be applied, a first electrode to which the pixel ground voltage is configured to be applied, and a second electrode connected to the fifth node;
the fifth switch element includes a gate electrode to which a fifth scan signal is configured to be applied, a first electrode to which the pixel driving voltage is configured to be applied, and a second electrode connected to the first node; and
the sixth switch element includes a gate electrode to which an emission control signal is configured to be applied, a first electrode connected to the second node, and a second electrode connected to the light-emitting element.

18. The display device of claim 17, wherein each of the pixel circuits further includes:
a third-a switch element that includes a gate electrode to which the third scan signal is configured to be applied, a first electrode to which a reference voltage is configured to be applied, and a second electrode connected to the third node.
